(19) United States
(12) Patent Application Publication
(10) Pub. No.: US 2026/0217451 A1
(43) Pub. Date: Jul. 30, 2026

(54) Waste Press

(71) Applicant: Michael Macchia, Wood-Ridge, NJ (US)

(72) Inventor: Michael Macchia, Wood-Ridge, NJ (US)

(21) Appl. No.: 17/980,176

(22) Filed: Nov. 3, 2022

(51) Int. Cl. B65F 1/14

(52) U.S. Cl. CPC B65F 1/1405; B65F 2240/138

(57) ABSTRACT

The product will be called “Waste Press” and will be used to press/push refuse, of any type, into a receiving waste receptacle. One use will be to press yard waste (grass, leaves, etc.) down and into a recyclable paper bag while keeping the users hands clean by way of its integrated handle. Storage of the bag will be maximized by compressing its contents compactly and in doing so removing trapped air via the tools open vent holes and freeing up voids or dead space in between the bagged material.

### BACKGROUND OF THE INVENTION

### Field of the Invention

The present invention relates generally to waste management tools, and more particularly to a hand-operated press tool designed to compress waste, yard debris, and other materials into a receptacle.

### Background of the Invention

Compressing material into a receptacle can be a dirty, inefficient, and sometimes dangerous task. For example, pushing leaves, grass, and other garden material or debris into a recyclable brown paper bag presents several challenges. If the material is not pushed down, the bag is left mostly filled with air and voids, thereby wasting storage space. If the user pushes the material down by hand, the method is mildly effective but inefficient, dirty, and at times unsafe. Using one's hands to compact material also risks injury from direct contact with the contents.

Each year, millions of 30-gallon lawn bags are discarded that could have held at least 25% to 50% more waste. This costly and wasteful practice adds up exponentially across households nationwide.

### SUMMARY OF THE INVENTION

The present invention provides a Waste Press tool that enables users to precisely and efficiently compress material into a receptacle. The tool provides a generous surface area plate that presses evenly in a smooth and effortless manner. Equipped with an integrated handle, the user does not need to touch the material with their own hands during use. Air vent holes in the plate allow trapped air to conveniently escape as additional room is created in the receptacle, thereby maximizing the storage capacity of the receptacle.

The present invention offers the following advantages:
Efficient and maximized receptacle or bag loading;
Integrated handle for safer compression of material;
Keeps hands cleaner during use;
Lightweight construction;
Recyclable composition upon disposal; and
Vented air holes for efficient compression.

### BRIEF DESCRIPTION OF THE DRAWINGS

FIG. 1 is a top-down concept drawing of the Waste Press.

FIG. 2 is a side profile concept drawing of the Waste Press.

FIG. 3 is a concept dimensional drawing of the Waste Press.

### DETAILED DESCRIPTION OF THE PREFERRED EMBODIMENT

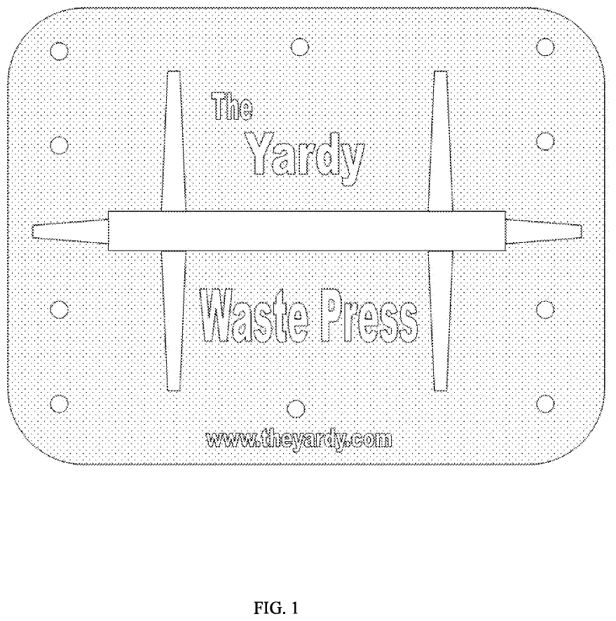

Referring now to FIG. 1, the surface area of the plate is shown, complete with air holes for ventilation during use, as well as the handle in the center along with support structures for handle stability and push-plate stability and strength. The tool may be manufactured in various types of materials including plastics (e.g., HDPE, PVC), metals (e.g., aluminum, steel), wood, and other similar and robust composite materials.

In the example of having leaves in a paper recyclable lawn bag, the Waste Press tool would be used to push down on the leaves and into the bag. The user controls the tool by holding the handle firmly and pushing down into the bag. Once the proper amount of resistance is noted, the user can retract the plate from the bag and continue to fill it further. The process is then repeated continuously until the bag is truly full and ready to be disposed.

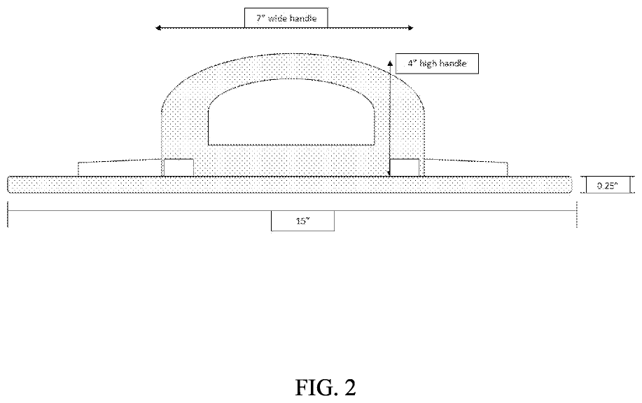

Referring now to FIG. 2, a side profile of the tool is shown, which illustrates the handle raised up and away from the plate, keeping the user's hands safe and clean.

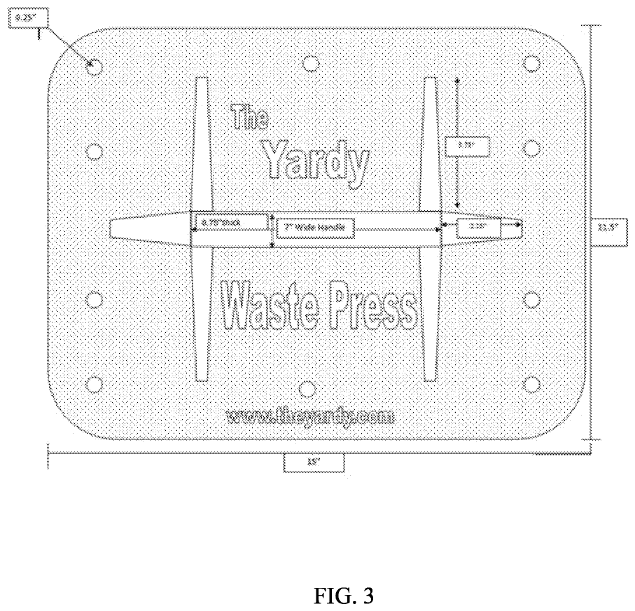

Referring now to FIG. 3, a dimensional drawing of the Waste Press is shown. The tool is approximately 35 inches in width. The handle is approximately 7 inches wide, 4 inches high, and 6.35 inches in total handle height. Support structures connect the handle to the press plate for structural stability and rigidity.

### METHOD OF USE

Step 1: Begin to fill the receptacle with content, such as grass clippings, leaves, and weeds.
Step 2: Once the bag has reached a certain capacity, for example 50%, insert the Waste Press into the bag and atop the contents.
Step 3: Grasp the handle firmly and ensure the press plate is laying flat atop the content.
Step 4: Push the tool into the receptacle slowly and steadily while distributing pressure evenly throughout.
Step 5: Once the material can no longer be compressed, remove the tool and continue filling the receptacle.
Step 6: Repeat from Step 2 until the receptacle has reached the desired content level and has maximized its storage capacity.

1) A surface area plate configured and designed to effectively compress material into a receptacle, the surface area plate comprising a) a solid surface b) a handle and c) one or more air holes in the solid surface of the surface area plate, the one or more air holes configured and designed to allow for trapped air to escape as the material is pressed into the receptacle, thereby creating more room in the receptacle.

2) The surface area plate according to claim 1, wherein the surface area plate has an area that is effectively the same size as a diameter of the receptacle.

3) The surface area plate of claim 1, wherein the surface area plate is made of plastic.

4) The surface area plate of claim 3, wherein the plastic is HDPE or PVC.

5) The surface area plate of claim 1, wherein the handle is designed and configured in a manner that allows a user to effectively press the surface area plate against the material in the receptacle, the handle being of a length that is substantially equivalent to a width of the surface area plate wherein the width of the surface area plate is substantially equivalent to a width of the receptacle.

6) A method of creating more space in a receptacle designed and configured to hold a material that is compressible, the method comprising using a surface area plate that comprises a) a solid surface b) a handle and c) one or more air holes in the solid surface of the surface area plate, wherein the solid surface is of a circumference that is substantially equivalent to a circumference of the receptacle, the solid surface being pressed using the handle against the material to compress the material in the receptacle, wherein the one or more air holes allow air to escape from the material through the solid surface when the material is compressed, thereby creating more space in the receptacle.

7) The method of claim 6, wherein the material is yard waste.

8) The method of claim 7, wherein the material is one or more of leaves, grass clippings, or weeds.
